(19) United States
(12) Patent Application Publication
(10) Pub. No.: US 2011/0058173 A1
(43) Pub. Date: Mar. 10, 2011

(54) METHOD FOR PRODUCING COLOR FORMULAS COMPRISING EFFECT PIGMENTS

(75) Inventors: Christian Bornemann, Munster (DE); Heiner Cloppenburg, Munster (DE); Carlos Vignolo, Hettstadt (DE); Jurgen Lohmann, Munster (DE)

(73) Assignee: BASF COATINGS GMBH, Munster (DE)

(21) Appl. No.: 12/936,742

(22) PCT Filed: Apr. 9, 2009
(86) PCT No.: PCT/EP09/02625

§ 371 Date: Nov. 23, 2010

(30) Foreign Application Priority Data
Apr. 14, 2008 (DE) 10 2008 018 910.3

(51) Int. Cl. G01J 3/46

(52) U.S. Cl. 356/425

(57) ABSTRACT

A method of preparing effect pigment color formulas matched to a color original, comprising the steps of

(a) producing a calibration series for each pigment included in the coloring system of an effect pigment color original,

(b) experimentally determining the reflectances R_{λ} of the color original and of the calibration series,

(c) calculating the optical parameters of the color original and of the constituents of the coloring system,

(d) selecting a suitable starting formula,

(e) determining the residual color difference between the starting formula and the color original,

(f) producing a first matched color formula,

(g) and repeating steps (e) and (f) until the residual color difference between the matched color formula and the color original is acceptable,

which involves
(i) transforming the reflectances R_{λ} of the color original and of the calibration series by means of a suitable mathematical function such that all of the transformed reflectances R′_{λ} lie between 0 and 1, and
(ii) calculating the optical parameters in accordance with the Kubelka-Munk approximation, using the transformed reflectances R′_{λ}.

The invention relates to a method of preparing effect pigment color formulas which can be matched in a few steps to a color original (target shade).

In the production of paint batches, especially in the automobile industry, an important task is to reproduce the shade, which is brought about by weighing-out of the amounts of the ingredients specified in a color formula, with as little deviation as possible from a target shade specified beforehand. The objective when tinting the batches is to match the shade of the batch to the target shade in as few tinting steps as possible, in the spirit of economics of the operation. This matching is performed by means of slight changes to the amounts of the colored ingredients included in the formula, such as chromatic pigments and effect pigments, for example, and also, where appropriate, by addition of further tinting adjuvants in small concentrations. The matching step is concluded only when the residual color difference between the shade of the batch and the target shade (color original) is acceptable.

Whereas the tinting procedure described was once primarily carried out visually, nowadays instrumental control measures are used definitively. These measures include, in particular, the use of a spectrophotometer, which is employed to record reflection spectra in the visible region of the electromagnetic spectrum, at different angles of illumination and observation. Combining these reflection spectra with an illuminant and with a respective one of the three standard spectral distribution functions produces coordinates which specify the color locus, i.e., the position of the shade under investigation within the color space. An established standard here is the color space of what are termed the CIELab coordinates L*, a*, and b*. Color differences dL*, da*, and db* are then produced from the difference between two color loci in terms of the coordinates L*, a*, and b* measured for each of the two shades under comparison.

In the reproduction of a target shade, the selection of a suitable starting formula from the reflection spectra obtained on the color original is determined by means of a radiative transfer model by determination of the optical parameters A_{λ} (absorption coefficient) and S_{λ} (scattering coefficient). These optical parameters are determined not only for the color original but also, separately, for the colored constituents included in the coloring system used, such as chromatic pigments and effect pigments, for example, and also, where appropriate, for further tinting adjuvants of the color system used, with the aid of corresponding calibration series of these constituents.

The optical parameters of mixtures, such as of color formulas, for example, are composed additively of the corresponding individual contributions of the constituents of the mixture. The individual contributions are weighted with the respective concentrations of the individual constituents. Accordingly, with knowledge of the optical parameters of the individual pigments of a coloring system, it is possible to calculate the concentrations of the individual pigments that are needed in order to obtain a mixture having, approximately, the optical parameters of the color original.

The pigments of a coloring system may comprise, for example, chromatic pigments and effect pigments. Chromatic pigments absorb visible light of defined wavelengths of the electromagnetic spectrum. They therefore reflect only part of the light which is reflected by white pigments.

In the instrument-based measurement of reflection spectra, the reference point is a white standard which is assumed to be an ideally matt-white surface and whose reflectances amount to exactly 1 by definition for all wavelengths of visible light. Owing to the absorption properties of the chromatic pigments, therefore, the reflection spectra of chromatic pigments have reflectances between 0 and 1 for wavelengths in the visible range of light.

A suitable and known technique for calculating the optical parameters of chromatic pigments is the Kubelka-Munk approximation of the radiative transfer equation. In the context of this approximation, a simple relationship is derived between the reflection spectra of, for example, an opaque paint film and the scattering coefficients and absorption coefficients of the pigments included in said film. The wavelength-dependent optical parameters (scattering and absorption coefficients) of chromatic pigments are determined experimentally for each pigment by producing calibration series, measuring reflection spectra, and applying the Kubelka-Munk approximation, in a way which is known to the skilled worker.

For effect pigments, however, the simple Kubelka-Munk approximation of the radiative transfer equation is not directly applicable. In contrast to chromatic pigments, effect pigments possess a significant three-dimensional extent, typically around 5 to 40 μm in lateral direction with a thickness of around 5 μm. As a result of this, in the case of aluminum pigments, for example, there is directed reflection of the incident light, with the consequence that the degree of reflection may exceed that of a white pigment. The reflectances determined in comparison to the white standard may therefore exceed the level of 1 in the case of effect pigments. This is particularly true in the case of the uniformly flat orientation of the effect pigments in the paint film, as is desired for metallic coatings. Since, however, the application of the Kubelka-Munk approximation of the radiative transfer equation is limited to reflectances between 0 and 1, it cannot be used to determine the optical parameters of effect pigment color formulas.

DE 19720887 A1 describes a method of calculating color formulas in the area of effect-imparting surface coatings. It determines the optical parameters for effect pigments by using the azimuth-independent form of the radiative transfer equation. Experimentally, pigments known as pseudopigments are formed from the effect pigments, by mixing the platelet-shaped effect pigments in each case with a fixed amount of one or more fillers which influence the topology but are otherwise coloristically inactive. This disrupts the flat orientation of the platelets in the paint film. The optical parameters of the pseudopigments thus obtained are therefore determined via a calibration series, in a procedure analogous to that for the other pigments included in a colorant system.

A disadvantage of the known methods, however, is that they involve great cost and complexity in reproducing effect pigment color formulas, since they fail to offer any possibility of utilizing the simple Kubelka-Munk approximation of the radiative transfer equation for effect pigments as well.

It is an object of the invention, therefore, to provide a method of calculating effect pigment color formulas that allows the use of the Kubelka-Munk approximation even for pigments with reflectances >1 and hence allows effect pigment shades to be reproduced without great time consumption and with a reduced number of color tinting steps.

This object is achieved through the provision of the method of the invention.

Surprisingly it has emerged that a method of preparing effect pigment color formulas matched to a color original, comprising the steps of

(a) producing a calibration series for each pigment included in the coloring system of an effect pigment color original,

(b) experimentally determining the reflectances R_{λ} of the color original and of the calibration series,

(c) calculating the optical parameters of the color original and of the constituents of the coloring system,

(d) selecting a suitable starting formula,

(e) determining the residual color difference between the starting formula and the color original,

(f) producing a first matched color formula,

(g) and repeating steps (e) and (f) until the residual color difference between the matched color formula and the color original is acceptable,

which comprises

(i) transforming the reflectances R_{λ} of the color original and of the calibration series by means of a suitable mathematical function such that all of the transformed reflectances R′_{λ} lie between 0 and 1, and
(ii) calculating the optical parameters in accordance with the Kubelka-Munk approximation, using the transformed reflectances R′_{λ},
permits an improvement to the existing methods through a reduction in the time involved and the number of color tinting steps required.

The term “coloring systems” refers to any desired systems of absorption pigments and/or effect pigments. There are no restrictions whatsoever on the number or selection of the pigment components. They can be matched as desired to the particular requirements. It is possible, for example, for such a coloring system to be based on all of the pigment components of a standardized mixer paint system.

The color-imparting absorption pigments are, for example, typical organic or inorganic absorption pigments that can be used in the coatings industry. Examples of organic absorption pigments are azo pigments, phthalocyanine pigments, quinacridone pigments, and pyrrolopyrrol pigments. Examples of inorganic absorption pigments are iron oxide pigments or lead oxide pigments, titanium dioxide, and carbon black.

By effect pigments are meant all pigments which exhibit a plateletlike structure and endow a surface coating with special decorative effects. The effect pigments are, for example, all of the effect-imparting pigments which can be used typically in vehicle finishing and industrial coating or in the production of inks and colorants. Examples of such effect pigments are pure metal pigments such as aluminum, iron or copper pigments, interference pigments such as titanium dioxide-coated mica, iron oxide-coated mica, mixed oxide-coated mica, metal oxide-coated mica, for example, or liquid-crystal pigments.

For the actual recording of the reflection spectra it is possible to use a fixed or portable goniospectrophotometer with symmetrical or asymmetrical measuring geometry. Instruments with modulated illumination and instruments with modulated observation can both be used. The number of different angles of illumination and/or of observation at which the measurements are carried out can be the number needed for sufficient characterization of the color original and of the pigments of the coloring system. If such measurement produces reflectances >1, then they are likewise taken into account in the determination of the optical parameters that is described below.

The optical parameters are determined by adapting the radiative transfer equation in the sense of an L₂ standard to the reflection spectra determined experimentally for each pigment. This is done using the Kubelka-Munk approximation of the radiative transfer equation:

(1−R_{λ})²/2R_{λ}=A_{λ}/S_{λ}

in which R_{λ} is the reflectance, A_{λ} is the absorption coefficient, and S_{λ} is the scattering coefficient, at the wavelength λ. The Kubelka-Munk model has established itself within the coatings industry over many decades, since it can be solved easily and quickly with high accuracy in the approximation of coats of infinite thickness (hiding power). Application of the Kubelka-Munk model, however, is confined to those cases where the reflectances R_{λ} in the visible range adopt values only between 0 and 1 (0<R_{λ}<1).

In accordance with the invention, therefore, when reflectances R_{λ} occur that are greater than 1, all of the reflectances R_{λ} of the color original and of the calibration series are first transformed by means of a suitable mathematical function such that the transformed reflectances R′_{λ} lie between 0 and 1. All of the reflectances here are transformed in the same way. Transformation is carried out using any desired suitable mathematical function. Suitable for this purpose is any function which, when applied, maintains the proportionality of the reflectances to one another and after whose application the transformed reflectances R′_{λ} lie between 0 and 1 (0<R′_{λ}<1). By way of example, the transformation of the reflectances R_{λ} to R′_{λ} may take place by means of division by a factor f:

R′_{λ}=R_{λ}/f.

The factor f is chosen such that all of the transformed reflectances lie between 0 and 1.

Then, using the transformed reflectances R′_{λ}, the optical parameters of the color original and of the calibration series are determined by means of the Kubelka-Munk approximation of the radiative transfer equation in the way which is known to the skilled worker. The selection of the starting formula and also the determination of the residual color difference take place likewise in a way which is known to the skilled worker.

The result of the Kubelka-Munk calculation, following selection of the starting formula, is the optical parameters A′_{λ} and S′_{λ} of the starting formula. From these it is then possible to determine the theoretical reflectances R′_{λ,th} of the starting formula in accordance with the Kubelka-Munk approximation. The difference ΔR′λ=R′_{λ}−R′_{λ,th}, where R′_{λ} relates to transformed reflectances of the color original and R′_{λ,th} refers to theoretical reflectances of the starting formula, is a measure of the accuracy of the Kubelka-Munk calculation for the wavelength under consideration. Integration over the region of the visible spectrum from 400 to 700 nm produces from this figure the Kubelka-Munk error ΔR′:

ΔR′=_{(400 nm)}∫^{(700 nm)}(R′_{λ}−R′_{λ,th}dλ

The use of transformed reflectances R′_{λ} in the Kubelka-Munk model may impair the accuracy of the Kubelka-Munk calculation. The error ΔR′ is calculated on the basis of the transformed reflectances R′_{λ}. As a result of back-transformation of the reflectances R′_{λ} to R_{λ}, the value of the Kubelka-Munk error undergoes change. The back-transformation of the reflectances R′_{λ} is accomplished by inverting the mathematical function used for the transformation. If the transformation, for example, was carried out by means of division by the factor f, then the back-transformation is accomplished by multiplication by the factor f. In this case the Kubelka-Munk error as well is increased by the factor f, with the consequence that:

ΔR=f·R′=f·_{(400 nm)}∫^{(700 nm)}(R′_{λ}−R′_{λ,th})dλ

In comparison to the results of a conventional Kubelka-Munk calculation for absorption pigments, this implies an enlargement of the error by the factor f.

Independently of any possible increase in the Kubelka-Munk error, however, it is surprisingly found in actual practice that the method of the invention enables a significant reduction to be achieved in the cost and complexity associated with elaborating the shades of color formulas that contain effect pigment. Through the method of the invention there is a drop in the number of tinting steps required and hence in the time involved in matching the effect pigment color formula to the target shade. This state of affairs is illustrated below with reference to the figure, without restricting the invention thereto. In the figure

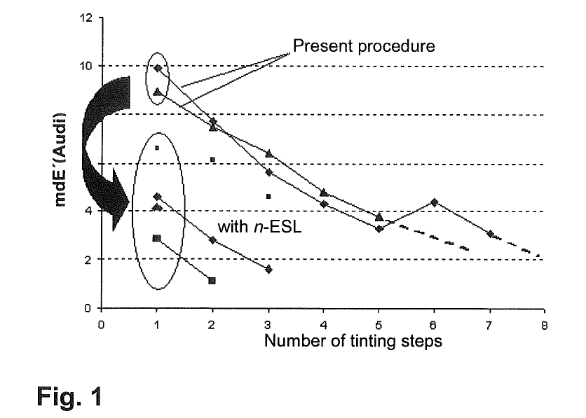

FIG. 1 shows a diagrammatic representation of shade reproduction by means of the method of the invention (n-ESL) in comparison to the conventional method.

For the same target shade, starting from the same reference mixture, a corrected shade is produced, by calculating a starting formula and carrying out stepwise correction, the corrected shade attaining an acceptable residual color difference with respect to the associated shade standard. As is apparent from the figure, the conventional method requires a substantially greater number of tinting steps in order to attain the target point than is the case in the new method of the invention. One characteristic of the method of the invention is that even the first tinting step already results in a very high degree of approximation to the target point. By means of the method of the invention it is possible to achieve the specification limits within a few tinting steps within a short amount of time.

The method of the invention can be used, for example, to tint paints and printing inks or polymer dispersions.

An advantage of the method of the invention is that it simplifies the reproduction of effect pigment shades. The method of the invention allows effect pigment color formulas to be matched to a target shade using the established Kubelka-Munk calculation for effect pigments, since through the method of the invention as well it is possible to take even reflectances >1 into account. The method of the invention reduces the number of tinting steps required until the specification limits on effect pigment color originals are attained, and reduces the time involved in reproducing them.

1. A method of preparing an effect pigment color formula matched to a color original, comprising,
(a) producing a calibration series for each pigment included in a coloring system of an effect pigment color original,
(b) determining reflectances R_{λ} of the effect pigment color original and of the calibration series,
(c) calculating optical parameters of the effect pigment color original and of constituents of the coloring system,
(d) selecting a starting formula,
(e) determining a residual color difference between the starting formula and the effect pigment color original,
(f) producing a first matched color formula,
(g) and repeating steps (e) and (f) until the residual color difference between the matched color formula and the effect pigment color original is acceptable,
which further comprises
(i) transforming the reflectances R_{λ} of the effect pigment color original and of the calibration series by means of a mathematical function such that all of the transformed reflectances R′_{λ} lie between 0 and 1, and
(ii) calculating the optical parameters in accordance with the Kubelka-Munk approximation, using the transformed reflectances R′_{λ}.

2. The method of claim 1, wherein the reflectances R_{λ} are transformed by means of division by a factor f.

3. A method of modifying a material, comprising using the method of claim 1 to tint a paint, printing ink or polymer dispersion.
